(19) United States
(12) Patent Application Publication
(10) Pub. No.: US 2023/0325929 A1
(43) Pub. Date: Oct. 12, 2023

(54) SYSTEMS AND METHODS FOR TRAINING MACHINE LEARNING CLASSIFICATION MODELS TO GENERATE INVESTMENT DATA PREDICTIONS

(71) Applicant: FMR LLC, Boston, MA (US)

(72) Inventors: John Dance, Chung Hom Kok (HK); Amit Shavit, Boston, MA (US); Vineel Gujjar, Cumberland, RI (US); Michael Canny, Somerville, MA (US); John Avery, Cambridge, MA (US)

(21) Appl. No.: 18/210,442

(22) Filed: Jun. 15, 2023

Related U.S. Application Data
(63) Continuation-in-part of application No. 16/839,616, filed on Apr. 3, 2020, now abandoned.
(60) Provisional application No. 62/829,076, filed on Apr. 4, 2019.

(51) Int. Cl. G06Q 40/06

(52) U.S. Cl. CPC G06Q 40/06

(57) ABSTRACT

Systems and methods for scoring investment data using machine learning-based model training. The method includes receiving historical data over a time period. The method further includes determining positive investment data and negative investment data based on the historical data and investment preference data. The positive investment data including characteristics associated with positive assets that align with the investment preference data. The negative investment data including characteristics associated with negative assets that misalign with the investment data. The method further includes calculating machine learning model parameters based on the positive and negative investment data. The method also includes calculating a score corresponding to a new asset based on the machine learning model parameters and new investment data. The method further includes determining whether the new investment data aligns with the investment preference data based on the score and a threshold investment score.

### RELATED APPLICATIONS

This application is a continuation-in-part of U.S. patent application Ser. No. 16/839,616, filed on Apr. 3, 2020, which claims the benefit of priority to U.S. Provisional Patent Application No. 62/829,076, filed Apr. 4, 2019, the entire contents of each of which are incorporated by reference herein.

### TECHNICAL FIELD

The present invention relates generally to systems and methods for generating user-specific trained machine learning classification models using historical data, including systems and methods for scoring investment data using the trained classification models.

### BACKGROUND

Historically, portfolio managers are professionals responsible for making investment decisions on behalf of clients. Portfolio managers are responsible for establishing an investment strategy or philosophy. Generally, the goal of an investment philosophy is to select appropriate investments such that the investments, as a whole, earn a greater return than a given level of risk. Portfolio managers often work with teams of analysts and researchers to develop and apply a successful investment philosophy.

In response to these challenges, manual analysis or rule-backed stock screeners have been employed by portfolio managers to review a large universe of stocks, sometimes tens of thousands, in an attempt to identify successful investable companies. However, manual analysis is effort intensive and difficult to apply consistently. Further, rule-based systems force portfolio managers to express their complex philosophy in terms of simplistic rules that may not adequately capture the philosophy.

### SUMMARY OF THE INVENTION

Accordingly, an object of the invention is to provide portfolio managers with systems and methods for analyzing investment data. It is an object of the invention to provide portfolio managers with systems and methods for analyzing investment data over a time period. It is an object of the invention to provide portfolio managers with systems and methods for analyzing investment data using a machine learning-based model. It is an object of the invention to provide portfolio managers with systems and methods for training machine learning-based models using historical data. It is an object of the invention to provide portfolio managers with systems and methods for scoring investment data using machine learning-based model training.

In some aspects, a method for scoring investment data using machine learning-based model training includes receiving, by a server computing device, historical data from a first database. The historical data includes investment data over a time period. The method further includes determining, by the server computing device, positive investment data based on the historical data and investment preference data. The positive investment data includes characteristics associated with positive assets that align with the investment preference data. The method also includes determining, by the server computing device, negative investment data based on the historical data and the investment preference data. The negative investment data includes characteristics associated with negative assets that misalign with the investment preference data.

Further, the method includes calculating, by the server computing device, machine learning model parameters based on the positive investment data and the negative investment data. The method also includes receiving, by the server computing device, new investment data from a second database. The new investment data includes characteristics of a new asset. The method further includes calculating, by the server computing device, a score corresponding to the new asset based on the machine learning model parameters and the new investment data. The score corresponds to a probability of alignment with the investment preference data. Further, the method includes determining, by the server computing device, whether the new investment data aligns with the investment preference data based on the score and a threshold investment score.

In some embodiments, the investment data includes stock prices for companies. In other embodiments, the time period includes one of five years, six years, seven years, eight years, or nine years. In some embodiments, the investment preference data corresponds to an investment preference of a portfolio manager.

In some embodiments, the server computing device is configured to generate stock charts based on the historical data. In other embodiments, the server computing device is configured to generate the positive investment data and the negative investment data based on the generated stock charts.

In some embodiments, the score includes a value ranging from 0 to 1. For example, in some embodiments, the threshold investment score includes a value of about 0.5.

In some embodiments, the machine learning model parameters correspond to a trained machine learning model. In other embodiments, the server computing device is configured to calculate new machine learning model parameters based on the positive investment data, the negative investment data, and the new investment data.

In some aspects, a system for scoring investment data using machine learning-based model training includes a server computing device communicatively coupled to a first database and a second database. The server computing device is configured to receive historical data from the first database. The historical data includes investment data over a time period. The server computing device is also configured to determine positive investment data based on the historical data and investment preference data. The positive investment data includes characteristics associated with positive assets that align with the investment preference data. Further, the server computing device is configured to determine negative investment data based on the historical data and the investment preference data. The negative investment data includes characteristics associated with negative assets that misalign with the investment preference data.

The server computing device is also configured to calculate machine learning model parameters based on the positive investment data and the negative investment data. The server computing device is further configured to receive new investment data from a second database. The new investment data includes characteristics of a new asset. The server computing device is also configured to calculate a score corresponding to the new asset based on the machine learning model parameters and the new investment data. The score corresponds to a probability of alignment with the investment preference data. The server computing device is further configured to determine whether the new investment data aligns with the investment preference data based on the score and a threshold investment score.

In some embodiments, the investment data includes stock prices for companies. In other embodiments, the time period includes one of five years, six years, seven years, eight years, or nine years. In some embodiments, the investment preference data corresponds to an investment preference of a portfolio manager.

In some embodiments, the server computing device is configured to generate stock charts based on the historical data. In other embodiments, the server computing device is configured to generate the positive investment data and the negative investment data based on the generated stock charts.

In some embodiments, the score includes a value ranging from 0 to 1. For example, in some embodiments, the threshold investment score includes a value of about 0.5.

In some embodiments, the machine learning model parameters correspond to a trained machine learning model. In other embodiments, the server computing device is configured to calculate new machine learning model parameters based on the positive investment data, the negative investment data, and the new investment data.

The invention, in another aspect, features a system for re-training an investment recommendation classification model using active learning. The system comprises a server computing device having a memory for storing computer-executable instructions and a processor that executes the computer-executable instructions. The server computing device trains an investment classification model on a corpus of labeled investment data, the trained investment classification model configured to generate investment philosophy alignment predictions for a plurality of portfolio managers. The server computing device samples a re-training dataset from a corpus of unlabeled investment data. The server computing device executes the trained investment classification model using the re-training dataset as input to generate labels for the investment data in the re-training dataset. The server computing device receives a change to one or more of the generated labels from a remote computing device. The server computing device re-train the trained investment classification model on the changed re-training dataset. The server computing device generates a prediction of investment philosophy alignment for one or more portfolio managers and one or more investment data points using the re-trained investment classification model.

The invention, in another aspect, features a computerized method of re-training an investment recommendation classification model using active learning. A server computing device trains an investment classification model on a corpus of labeled investment data, the trained investment classification model configured to generate investment philosophy alignment predictions for a plurality of portfolio managers. The server computing device samples a re-training dataset from a corpus of unlabeled investment data. The server computing device executes the trained investment classification model using the re-training dataset as input to generate labels for the investment data in the re-training dataset. The server computing device receives a change to one or more of the generated labels from a remote computing device. The server computing device re-train the trained investment classification model on the changed re-training dataset. The server computing device generates a prediction of investment philosophy alignment for one or more portfolio managers and one or more investment data points using the re-trained investment classification model.

The invention, in another aspect, features a system for generating an investment classification model using transfer learning. The system comprises a server computing device having a memory for storing computer-executable instructions and a processor that executes the computer-executable instructions. The server computing device receives output from a plurality of trained investment classification models for one or more existing portfolio managers, the output comprising investment data and corresponding labels generated by the plurality of trained models. The server computing device generates an initial training dataset for training a new investment classification model, including removing one or more investment data points from the output received from the plurality of trained models that are labeled as noise. The server computing device trains a new investment classification model using the filtered training dataset as input to generate investment philosophy alignment predictions for a new portfolio manager.

The invention, in another aspect, features a computerized method for generating an investment classification model using transfer learning. A server computing device receives output from a plurality of trained investment classification models for one or more existing portfolio managers, the output comprising investment data and corresponding labels generated by the plurality of trained models. The server computing device generates an initial training dataset for training a new investment classification model, including removing one or more investment data points from the output received from the plurality of trained models that are labeled as noise. The server computing device trains a new investment classification model using the filtered training dataset as input to generate investment philosophy alignment predictions for a new portfolio manager.

The invention, in another aspect, features a system for generating a discriminative investment classification model using noisy ground truth data. The system comprises a server computing device having a memory for storing computer-executable instructions and a processor that executes the computer-executable instructions. The server computing device generates noisy labels for a corpus of unlabeled investment data using one or more labeling functions. The server computing device learns a deep generative model using the unlabeled investment data and the noisy labels. The server computing device applies the deep generative model to the unlabeled training data to predict probabilistic labels for the unlabeled training data. The server computing device generates a probabilistic training dataset using the unlabeled training data and the probabilistic label. The server computing device trains a discriminative investment classification model using the probabilistic training dataset as input. The server computing device generates a prediction of investment philosophy alignment for one or more portfolio managers and one or more investment data points using the trained discriminative investment classification model.

The invention, in another aspect, features a computerized method of generating a discriminative investment classification model using noisy ground truth data. A server computing device generates noisy labels for a corpus of unlabeled investment data using one or more labeling functions. The server computing device learns a deep generative model using the unlabeled investment data and the noisy labels. The server computing device applies the deep generative model to the unlabeled training data to predict probabilistic labels for the unlabeled training data. The server computing device generates a probabilistic training dataset using the unlabeled training data and the probabilistic label. The server computing device trains a discriminative investment classification model using the probabilistic training dataset as input. The server computing device generates a prediction of investment philosophy alignment for one or more portfolio managers and one or more investment data points using the trained discriminative investment classification model.

In some embodiments, the investment data comprises historical stock price data for a plurality of companies. In some embodiments, the server computing device uses a classification uncertainty sampling algorithm to sample the re-training dataset from the corpus of unlabeled investment data. In some embodiments, the labeling functions each comprise programmatic code corresponding to one or more rules or heuristics that express weak supervision.

Other aspects and advantages of the invention can become apparent from the following drawings and description, all of which illustrate the principles of the invention, by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is a block diagram of an exemplary data communications network according to embodiments of the technology described herein.

FIG. 2 is a block diagram of an exemplary server computing device and an exemplary mobile device according to embodiments of the technology described herein.

FIG. 3 is a diagram showing a visualization of an exemplary classification model building process according to embodiments of the technology described herein.

FIG. 4 is a diagram showing a visualization of an exemplary data collection process for the exemplary model building process shown in FIG. 3, according to embodiments of the technology described herein.

FIG. 5 is a diagram showing a visualization of an exemplary stock chart over a time period, according to embodiments of the technology described herein.

FIG. 6 is a diagram showing a visualization of an exemplary model scoring process, according to embodiments of the technology described herein.

FIG. 7 is a flow diagram of a computer-implemented method for scoring investment data using machine learning-based model training, according to embodiments of the technology described herein.

FIG. 8 is a block diagram of a system for re-training an investment recommendation classification model using active learning.

FIG. 9 is a flow diagram of a computerized method of re-training an investment recommendation classification model using active learning.

FIG. 10 is a block diagram of a system for generating an investment classification model using transfer learning.

FIG. 11 is a flow diagram of a computerized method of generating an investment classification model using transfer learning.

FIG. 12 is a block diagram of a system for generating a discriminative investment classification model using noisy ground truth data.

FIG. 13 is a flow diagram of a computerized method of generating a discriminative investment classification model using noisy ground truth data

### DETAILED DESCRIPTION

Portfolio managers study a large universe of stocks, sometimes tens of thousands, in attempt to identify successful investment companies. This screening of stocks is governed by the portfolio manager's proprietary investment philosophy, which entails manually reviewing trends in historical stock financial metrics and making investment judgements. The stock financial metrics that are considered include fundamentals such as stock price, sales, earning, and other derived metrics such as market sentiment, governance & compliance, and CEO performance perceptions. Clearly, this type of manual analysis is very effort intensive, and hard to apply consistently. Hence, rule-based stock screeners have historically been employed to help alleviate the burden. However, the rule-based systems themselves have their limitations, because it forces the portfolio manager to express his or her complex philosophy in terms of simplistic rules that might inadequately capture the philosophy.

In some aspects, the systems and methods described herein is a machine learning alternative to the stock screening process where an artificial intelligence-based classification model is trained by means of ground-truth examples or historical data, to mimic the investment philosophy of the portfolio manager. The trained classification model can be scalably applied to a large universe of investment data, and the scoring process can be repeated frequently as newer data becomes available, in order to closely track changes in stock performance. The systems and methods described herein provide a more comprehensive and scalable solution compared to manual analysis or rule-backed stock screeners.

In some aspects, the systems and methods described herein can include one or more mechanisms or methods for providing portfolio managers with systems and methods for analyzing investment data. The system and methods can include mechanisms or methods for analyzing investment data over a time period. The systems and methods described herein can facilitate portfolio managers by analyzing investment data using a machine learning-based model. The systems and methods described herein can include one or more mechanisms or methods for providing portfolio managers with systems and methods for training machine learning-based models using historical data. The systems and methods described herein can facilitate portfolio managers by scoring investment data using machine learning-based model training.

The systems and methods described herein can develop a set of scalable machine learning models that systematically learn a portfolio manager's philosophy by training the models using examples and characteristics of companies that the portfolio manager deems as potential winners. The machine learning models can continue to learn and adapt based on the stocks the portfolio manager chooses and continue to refine itself to better fit the portfolio manager's intended investment philosophy. Hence, the systems and methods described herein do not require the definition of a set of hard logical and/or static rules. Further, the systems and methods described herein do not seek to merely automate manual analytical processes by a portfolio manager, but rather replace the portfolio manager altogether by learning his or her preferences and using these preferences to select new investable companies without any human intervention. The predictions made by the machine learning models of the systems and methods described herein are adapted to eliminate potential human errors that can be made by a portfolio manager, such as irrational or emotion-driven decisions or erroneous data entry.

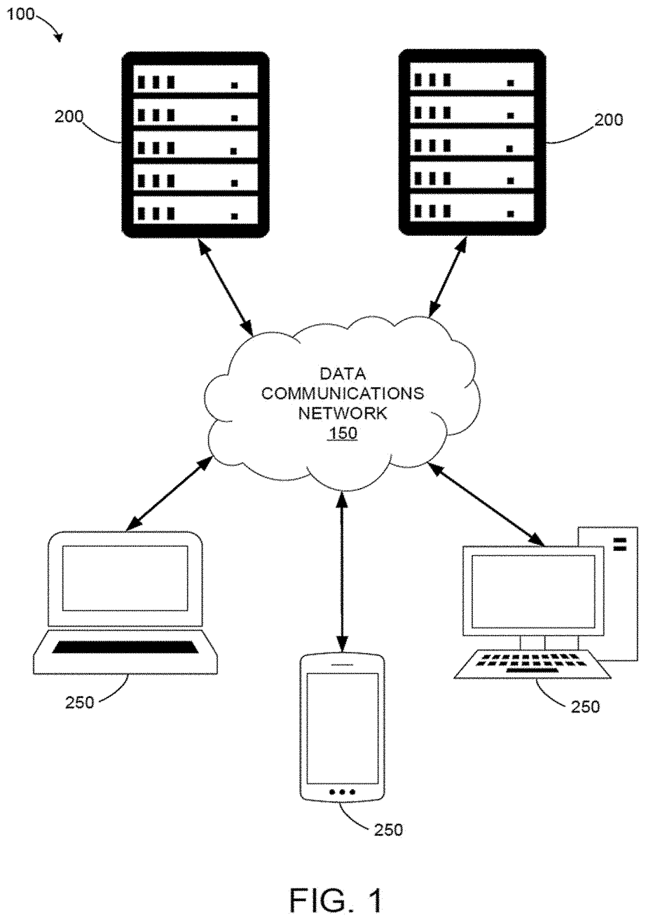

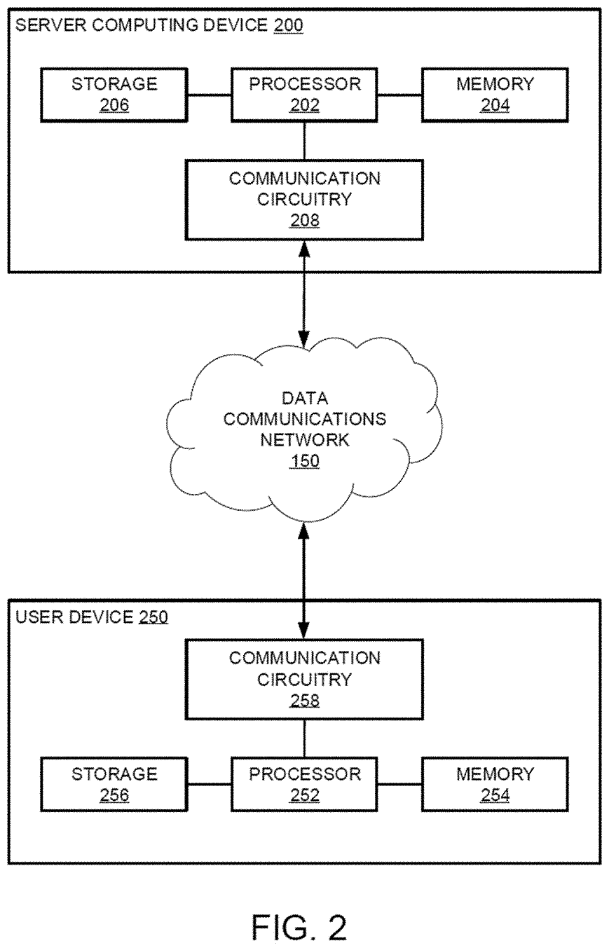

Referring to FIGS. 1 and 2, an exemplary communications system 100 includes data communications network 150, exemplary server computing devices 200, and exemplary mobile devices 250. In some embodiments, the system 100 includes one or more server computing devices 200 and one or more mobile devices 250. Each server computing device 200 can include a processor 202, memory 204, storage 206, and communication circuitry 208. Each mobile device 250 can include a processor 252, memory 254, storage 256, and communication circuitry 258. In some embodiments, communication circuitry 208 of the server computing devices 200 is communicatively coupled to the communication circuitry 258 of the mobile devices 250 via data communications network 150. Communication circuitry 208 and communication circuitry 258 can use Bluetooth, Wi-Fi, or any comparable data transfer connection. The mobile devices 250 can include personal workstations, laptops, tablets, mobile devices, or any other comparable device.

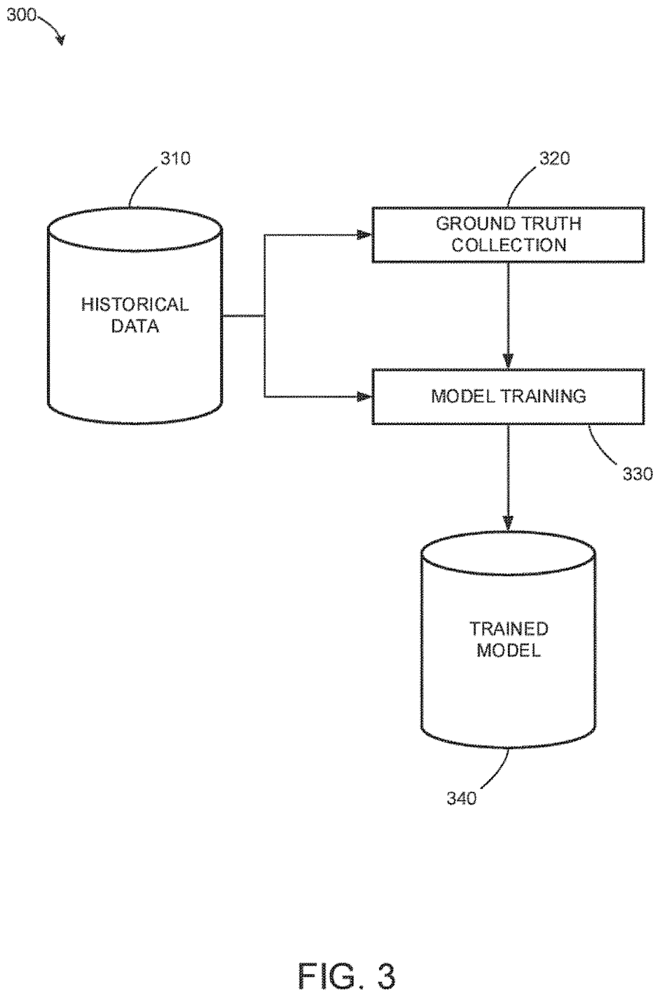

An exemplary classification model building process 300 is illustrated in FIG. 3. As shown, the model building process starts with collecting ground truth 320 from historical data 310. For example, the historical data 310 can include a dataset of stock charts. In some embodiments, historical data 310 includes the ticker symbol for a particular asset, the date for the metrics of the assets, the stock price, the price earnings ratio, the price to book ratio, the cumulative returns of the stock, the book value per share, the earnings per share, and relative metrics such as an index. The historical data 310 can be depicted in tabular form.

The ground-truth comprises historical examples of cases where the stock performance met the portfolio manager's expectations (hereinafter referred to as “positive class”), and those that did not (hereinafter referred to as “negative class”). Thus, the ground-truth dataset includes examples of stocks that align with the portfolio manager's investment preferences or philosophy, and those that don't. In some embodiments, the portfolio manager's investment philosophy can be classified as structural growth, disruptive growth, PE rerate, or noise (other). In other embodiments, the portfolio manager's investment philosophy can be classified as growth stocks, value stocks, core stocks, and dislike stocks.

The ground-truth data are then fed to a machine learning system as a part of model training 330. Model training 330 is an automated algorithmic process of identifying a mathematical formulation that can distinguish between the positive and the negative class. In simple terms, a machine learning model maps input data X to an output label Y using its trained parameters θ. The output of the model training process is a trained model 340. Specifically, the models of the systems and methods described herein are adapted to learn the intrinsic patterns and trends present in the ground truth data that appear to capture the subtle investment philosophy of the portfolio manager (e.g., distinguish between positive and negative investment criteria).

Furthermore, as additional ground truth samples enter the system, the models continue to re-train in the background and evaluate their performance through metrics such as precision, recall, area under the receiver operating characteristic curve, and F1 score. The trained models can then be applied in the future to never-seen-before datasets and generate predictions on those datasets without human intervention, such as without being processed/analyzed by the portfolio manager. The models can be used to score thousands of stocks in real time or near real time.

Several types of models can be used for model training. For example, XGBoost, GADF, LSTM classifier, or Inception CNN (or convolutional neural network) can be used as classification models. XGBoost is a standard machine learning classifier where each raw data from each training instance is transformed to a set of features. In some embodiments, the time-series data from the training instance is transformed into a 2D matrix using GADF (Gramian Angular Difference Field). The 2D matric can be interpreted as an image dataset, and standard Convolutional Neural Network classifiers can be trained using these “images” as input. Each time series of a metric forms a channel to the CNN.

In some aspects, ensembling Random Forest, XGBoost, and LightGBM models provides improvements over using only one of those models in isolation. This is primarily because each model works in different ways and is able to learn different patterns and trends in the data. Random Forest works by building trees that yield the best splits (i.e., the splits in the data that most reduce entropy) and continues recursively until stopping criterions are reached. Some tree pruning methods are then followed to help prevent overfitting and to reduce computational runtimes. In the tradeoff between variance and bias, Random Forest primarily goes after the variance by aggregating uncorrelated trees. XGBoost and LightGBM work differently than random forest, mainly by using a boosting algorithm, and in such, primarily go after the bias rather than the variance. XGBoost grows its trees depth-wise, while LightGBM grows its trees leaf-wise. Even this slight nuance in how these two models grow their trees generates enough of a difference between the models to capture different variance in the data, adding more value to ensembling.

All three models are optimized using the cross entropy objective function, and work on the same set of underlying features. The LightGBM uses the leaf-wise tree growing algorithm to build its trees throughout training. Features can be engineered using a wide array of extractive techniques. For example, looking at the range, min, max, mean, median over a growing time window for each series. In some embodiments, other techniques are used such as Fourier transforms of the original series with different lag parameters, autocorrelations over time, and various entropy measures. Up to hundreds of features are generated for each time series, which significantly help the models learn the various nuances present in each objective class. The models are ensembled together using the mean of their respective scores.

In some aspects, stock classification data can be modeled using computer vision models. For example, in some embodiments, the financial data is charted, and those charts are used as inputs to computer vision models such as Inception V3 or VGG16. Computer vision models can then be applied to the underlying financial data. Computer vision or convolutional neural network models can be applied on time series data using recurrence plots of such data. Converting a time series of price, for example, to its recurrence plot, generates a 2D representation of the time series.

Neural network models can then be applied to the underlying data. For example, long short term memory (LSTMs) and gated recurrent units (GRUs) can be employed to model the time series. Classical machine learning models can then be applied on the extracted features. For example, extracting features such as Fourier transforms, autocorrelations, periodicity, or peaks can be used as inputs to classical machine learning models such as logistic regressions, Random Forests, or extreme gradient boosted trees. Ensembling these models together yield improved performance and metrics. The models described herein can be interchanged and are automatically chosen and ensembled to maximize performance.

In some aspects, for some types of models, such as deep learning models, the model scoring process can be interpreted as a two stage process. For example, the first stage can convert the input instance into a vector of numbers. The vector of numbers are then used to generate the predicted class. The advantage of the two-stage interpretation is that each input instance can now be represented as a vector of numbers that encode the characteristics of the stock metrics. The sets of vectors can now be used to cluster similar instances. Each cluster can be evaluated by a Portfolio Manager for investment decisions in a semi-supervised fashion.

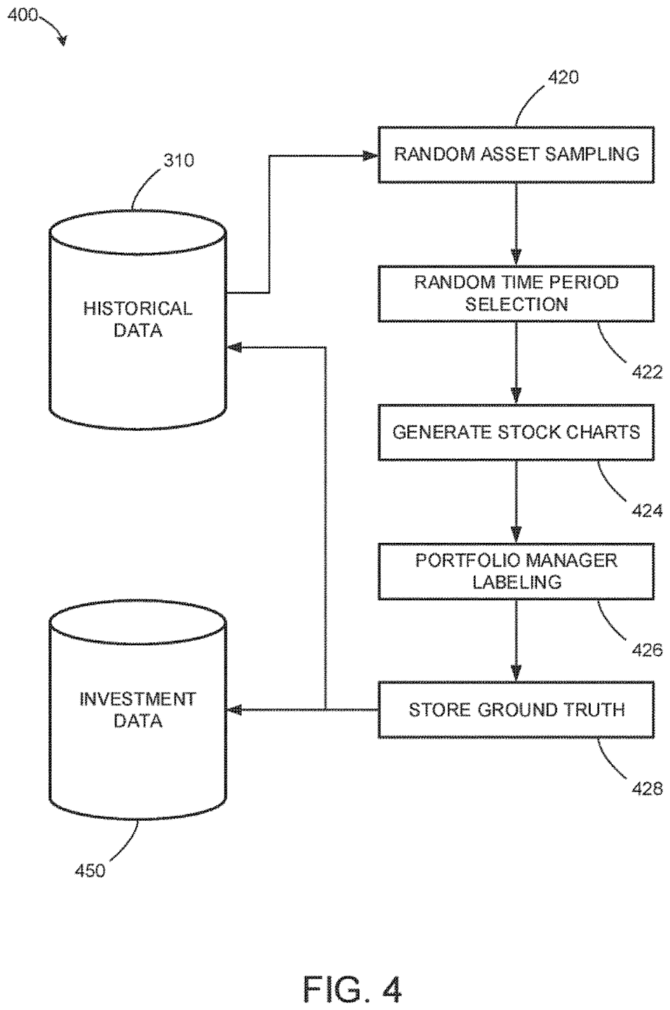

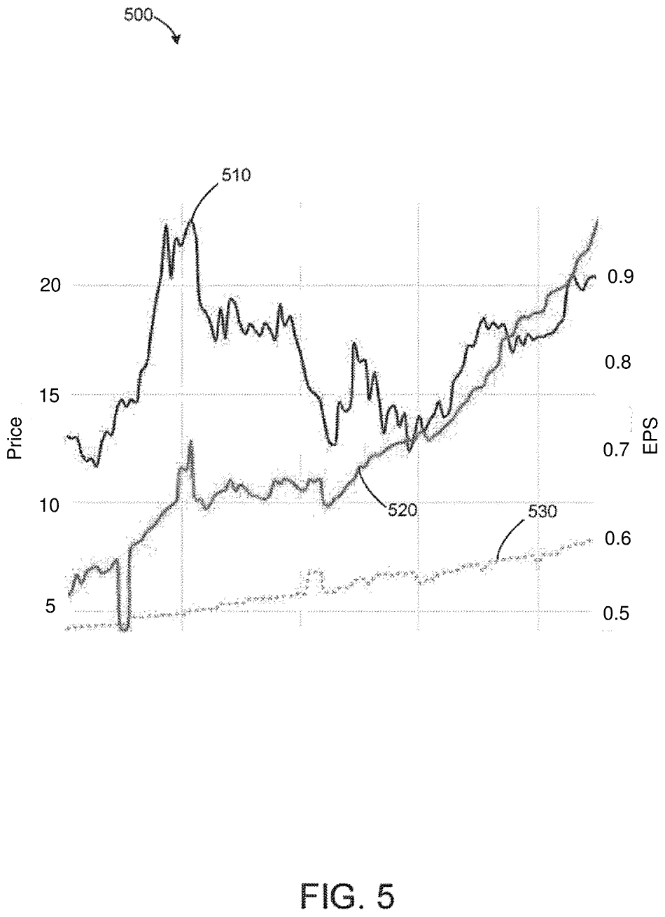

Referring to FIG. 4, an exemplary ground-truth collection process 400 is illustrated. Process 400 begins by randomly sampling an asset from historical data 310 at step 420 and randomly choosing a time period at step 422. Process 400 continues by generating a stock chart for the randomly sampled asset over the randomly chosen time period at step 424. For example, FIG. 5 illustrates an exemplary stock chart 500 for an asset over a time period of 8 years. Stock chart 500 illustrates the stock price 510, the earnings per share 520, and book value per share 530.

Process 400 continues by receiving a label from a portfolio manager for the generated stock chart at step 426. The portfolio manager labels the generated stock chart as potentially investible (positive class) or not potentially investible (negative class). Process 400 continues at step 428 by storing the label corresponding to the randomly sampled asset as investment data 450. The ground-truth collection process 400 returns to step 420 to randomly sample another asset from historical data 310. As discussed in relation to FIG. 3, the investment data 450 is then fed to the machine learning system as a part of model training 330.

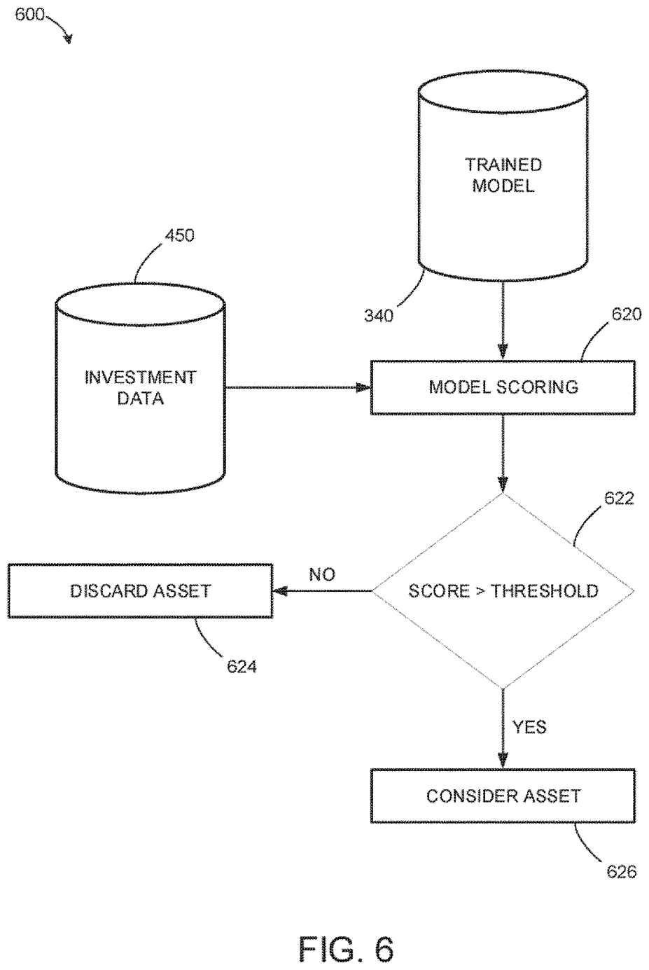

FIG. 6 illustrates an exemplary model scoring process 600. Process 600 begins by receiving a new asset to score from investment data 450. The new asset is scored at step 620 using the trained model 340. For a new asset, the model scoring process can generate an output probability score ranging from 0 to 1, where the higher the score, the higher the chance that the stock aligns with the portfolio manager's philosophy. The threshold is the value at which an asset is deemed aligned with the portfolio manager's preferences or philosophy. In some embodiments, the threshold is determined experimentally using statistics generated from the model training process. In other embodiments, the threshold investment score can be a value of about 0.5, about 0.6, about 0.7, about 0.8, or about 0.9. The model scoring process 600 can also be repeated periodically to track changes in stock performance over time.

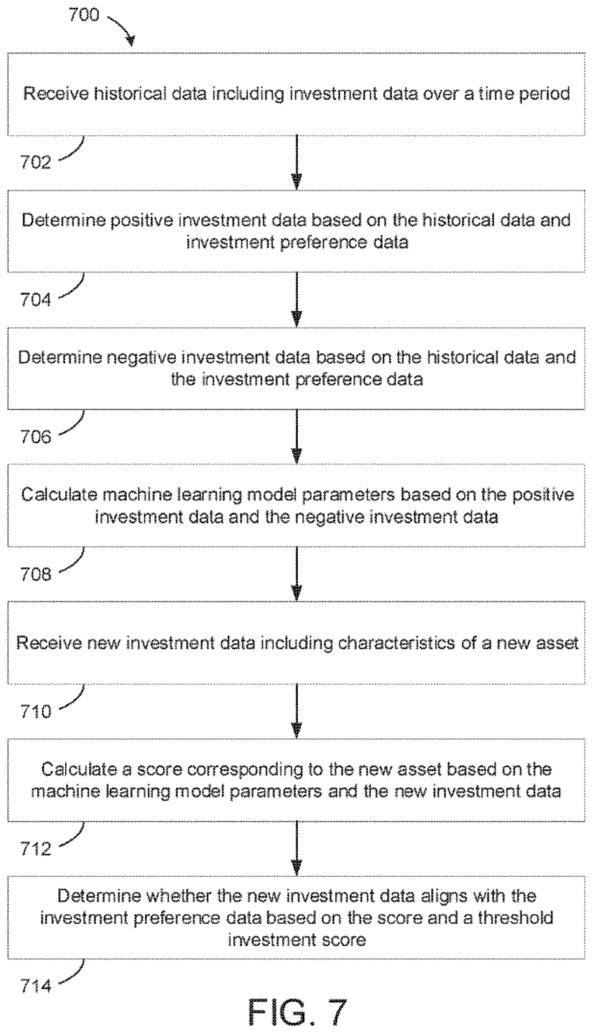

Referring to FIG. 7, a process 700 for scoring investment data using machine learning-based model training is illustrated. The process 700 begins by receiving, by a server computing device 200, historical data from a first database step 702. For example, in some embodiments, the historical data includes investment data over a time period. The investment data can include stock prices of companies listed on exchange markets. In some embodiments, the time period can be one of one year, two years, three years, four years, five years, six years, seven years, eight years, nine years, or ten years.

Process 700 continues by determining, by the server computing device 200, positive investment data based on the historical data and investment data in step 704. For example, in some embodiments, the positive investment data includes characteristics associated with positive assets that align with the investment preference data. The investment preference data can correspond to an investment preference of a portfolio manager.

Process 700 continues by determining, by the server computing device 200, negative investment data based on the historical data and the investment preference data in step 706. For example, in some embodiments, the negative investment data includes characteristics associated with negative assets that misalign with the investment preference data.

In some embodiments, the server computing device 200 can be configured to generate stock charts based on the historical data. For example, in some embodiments, the server computing device 200 can be configured to generate the positive investment data and the negative investment data based on the generated stock charts. In other embodiments, the positive investment data and the negative investment data can be generated based on feedback received by the portfolio manager.

Process 700 continues by calculating, by the server computing device 200, machine learning model parameters based on the positive investment data and the negative investment data in step 708. As discussed above in relation to FIGS. 3-5, the machine learning model parameters correspond to a trained machine learning model.

Process 700 continues by receiving, by the server computing device 200, new investment data from a second database in step 710. For example, in some embodiments, the new investment data includes characteristics of a new asset. A new asset can be a new stock that is being considered by the portfolio manager. In other embodiments, the server computing device can receive the new investment data from the first database.

Process 700 continues by calculating, by the server computing device 200, a score corresponding to the new asset based on the calculated machine learning model parameters and the new investment data in step 712. For example, in some embodiments, the score corresponds to a probability of alignment with the investment preference data. As discussed above in relation to FIG. 6, the score can be a value ranging from 0 to 1. In some embodiments, a score closer to 1 indicates that the probability of alignment with the investment preference data is high. Similarly, in some embodiments, a score closer to 0 indicates that the probability of alignment with the investment preference data is low.

Process 700 finishes by determining, by the server computing device 200, whether the new investment data aligns with the investment preference data based on the score and a threshold investment score in step 714. In some embodiments, the threshold investment score can be a value of about 0.5, about 0.6, about 0.7, about 0.8, or about 0.9. For example, in some embodiments, the server computing device 200 can determine that the new investment data aligns with the investment preference data if the score is above the threshold investment score.

In some embodiments, the server computing device 200 can be configured to calculate new machine learning model parameters based on the positive investment data, the negative investment data, and the new investment data. The new machine learning model parameters can be used by the server computing device 200 to calculate a new score corresponding to other assets.

As described above, generation of trained classification models using historical investment data is important in order to achieve accuracy and efficiency in the investment scoring process. The methods and systems described herein can advantageously utilize a number of different computerized techniques to generate the classification models (e.g., Random Forest, XGBoost, LightGBM) that are deployed to analyze investment data and generate investment recommendations for a portfolio manager's consideration.

Active Learning In one aspect, the systems and methods can use active learning (AL) techniques to refine existing classification models for improved accuracy. Generally, active learning is a process whereby a training set (also called a seeding set) is sampled from a large corpus of unlabeled data and labels and/or pseudolabels are applied to the training set, which is then used to re-train an existing classification model. Active learning enables the system to quickly generate labeled data for use in training the classification model without incurring the significant processing cost which can result from labeling a large amount of data. In some embodiments, the sampled training set comprises data that is predicted to be more informative for determining labels for unlabeled data. Additional information about the implementation of active learning techniques is described in A. Tsvigun et al., “Towards Computationally Feasible Deep Active Learning,” arXiv:2205.03598v1 [cs.CL] 7 May 2022, which is incorporated herein by reference.

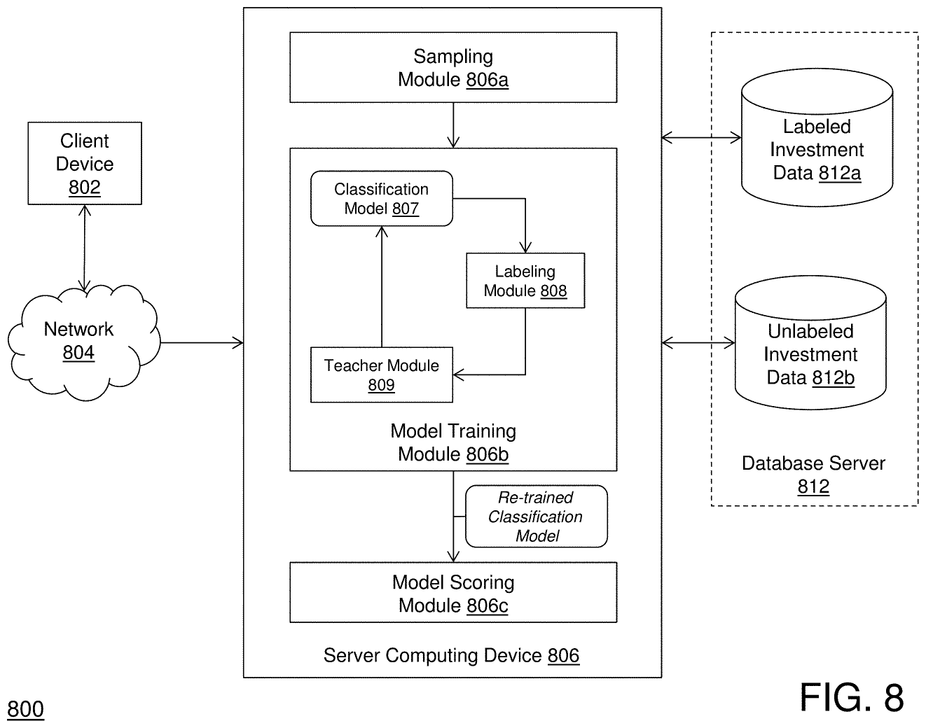

FIG. 8 is a block diagram of a system 800 for re-training an investment recommendation classification model using active learning. System 800 includes certain devices and components that are described above with respect to FIGS. 1-7 and those devices and components are discussed by way of reference thereto. As shown in FIG. 8, system 800 includes client computing device 802, communication network 804, server computing device 806 that includes sampling module 806a, model training module 806b, and model scoring module 806c. Model training module 806b includes trained classification model 807, labeling module 808, and teacher module 809. System 800 also includes database server computing device 812 that comprises historical data database 812a and unlabeled data database 812b.

Client computing device 802 connects to communication network 804 in order to communicate with server computing device 806 to provide input and receive output relating to the process of re-training an investment recommendation classification model using active learning as described herein. In some embodiments, client computing device 802 is coupled to an associated display device (not shown). For example, client computing device 802 can provide a graphical user interface (GUI) via the display device that is configured to receive input from a user of the device 802 and to present output (e.g., documents, reports, digital content items) to the user that results from the methods and systems described herein.

Exemplary client computing devices 802 include but are not limited to desktop computers, laptop computers, tablets, mobile devices, smartphones, and Internet appliances. It should be appreciated that other types of computing devices that are capable of connecting to the components of system 800 can be used without departing from the scope of invention. Although FIG. 8 depicts a single client computing device 802, it should be appreciated that system 800 can include any number of client computing devices.

Communication network 804 enables the client computing device 802 to communicate with server computing device 806. Network 804 is typically a wide area network, such as the Internet and/or a cellular network. In some embodiments, network 804 is comprised of several discrete networks and/or sub-networks (e.g., cellular to Internet).

Server computing device 806 is a device including specialized hardware and/or software modules that execute on a processor and interact with memory modules of server computing device 806, to receive data from other components of system 800, transmit data to other components of system 800, and perform functions for re-training an investment recommendation classification model using active learning as described herein. As mentioned above, server computing device 806 includes sampling module 806a, model training module 806b which includes trained classification model 807, labeling module 808, and teacher module 809, and model scoring module 806c which execute on one or more processors of server computing device 806. In some embodiments, modules 806a-806c, 808, 809 and model 807 are specialized sets of computer software instructions programmed onto one or more dedicated processors in server computing device 806 and can include designated memory locations and/or registers for executing the specialized computer software instructions.

Although modules 806a-806c, 808, 809 and model 807 are shown in FIG. 8 as executing within the same server computing device 806, in some embodiments the functionality of modules 806a-806c, 808, 809 and model 807 can be distributed among a plurality of server computing devices. As shown in FIG. 8, server computing device 806 enables modules 806a-806c, 808, 809 and model 807 to communicate in order to exchange data for the purpose of performing the described functions. It should be appreciated that any number of computing devices, arranged in a variety of architectures, resources, and configurations (e.g., cluster computing, virtual computing, cloud computing) can be used without departing from the scope of the invention. Exemplary functionality of modules 806a-806c, 808, 809 and model 807 is described in detail below.

Database server 812 is a computing device (or set of computing devices) coupled to server computing device 806 and the databases are configured to receive, generate, and store specific segments of data relating to the process of re-training an investment recommendation classification model using active learning as described herein. Database server 812 comprises a plurality of databases, including labeled investment data database 812a and unlabeled investment data database 812b. In some embodiments, all or a portion of the databases 812a-812b can be integrated with server computing device 806 or be located on a separate computing device or devices. Databases 812a-812b can comprise one or more databases configured to store portions of data used by the other components of system 800, as will be described in greater detail below.

As can be appreciated, labeled investment data database 812a comprises investment data that has been previously labeled to indicate whether the investment data or a portion thereof aligns with one or more investment strategies (i.e., an investment strategy preferred by a given portfolio manager (PM)). An example label can be a binary value (e.g., 0 for non-aligning or noise, 1 for aligning), an alphanumeric value (e.g., indicating the alignment determination), or other types of labeling mechanisms. The data in labeled investment data database 812a can comprise data that has been manually labeled (e.g., by the PM and/or an analyst) and/or data that has been previously analyzed and labeled by system 100 of FIG. 1 and/or system 800 of FIG. 8. In some embodiments, the labeled investment data comprises time series investment data. Unlabeled investment data database 812b comprises investment data that has not yet been labeled for alignment with an investment strategy—as explained herein, this data is sampled and analyzed by an existing trained (or pre-trained) classification model to determine alignment labels and/or pseudolabels, which are then used to re-train the existing classification model.

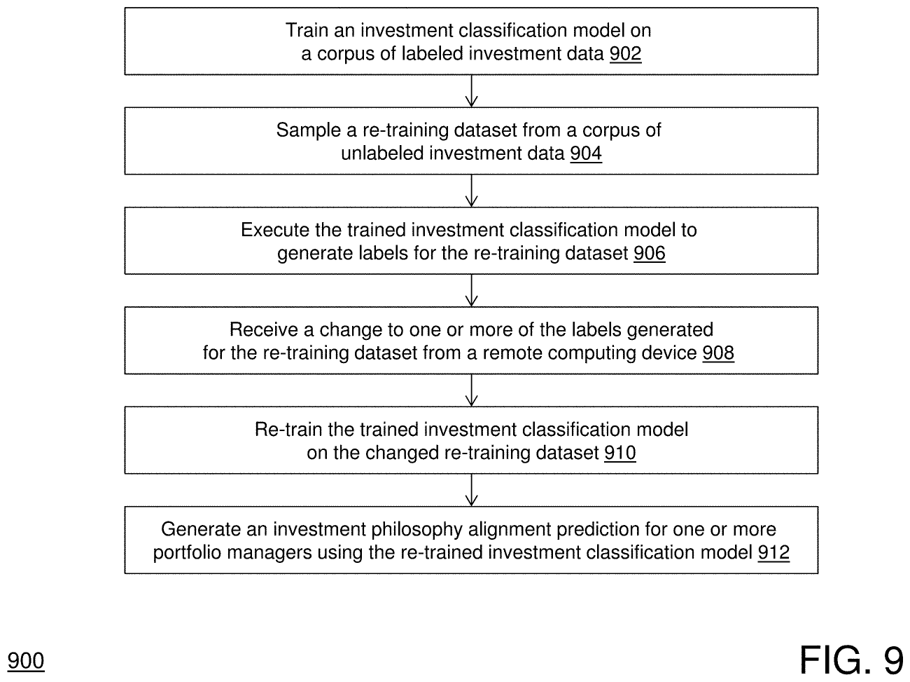

FIG. 9 is a flow diagram of a computerized method 900 of re-training an investment recommendation classification model using active learning, using system 800 of FIG. 8. Model training module 806b trains (step 902) an investment classification model on a corpus of labeled investment data. As described previously, model training module 806b can train a machine learning classification model 807 to predict investment alignment labels for unlabeled investment data (e.g., from database 812b) for one or more portfolio managers. The classification model 807 can comprise any of a number of different structures, including but not limited to convolutional neural networks, deep neural networks, Random Forest, supervised learning algorithms, among others. As can be appreciated, it is important to closely monitor the performance (e.g., accuracy, recall) of classification model 807 to determine whether the predictions generated by the model 807 remain accurate over time, because as the model 807 analyzes unlabeled data generated after the model is initially trained, the model's performance may degrade (e.g., the model may not be able to accurately interpret and classify the newer investment data) unless it is re-trained. Typically, a large amount of training data is required to re-train most types of classification models. However, as described herein, model training module 806b advantageously utilizes an active learning approach to re-train classification model 807 which requires significantly less training data.

To re-train model 807, sampling module 806a samples (step 904) a re-training dataset from a corpus of unlabeled investment data, such as stored in database 812b. In some embodiments, sampling module 806a is configured to apply a classification uncertainty sampling approach when generating the re-training dataset. Generally, classification uncertainty sampling selects sample data where the classifier is the most uncertain about the predicted label(s). Example classification uncertainty sampling algorithms that can be used by sampling module 806a are described in A. Raj and F. Bach, “Convergence of Uncertainty Sampling for Active Learning,” arXiv:2110.15784v1 [cs.LG] 29 Oct. 2021, available at arxiv.org/pdf/2110.15784.pdf; and modAL, “Uncertainty sampling,” 2018, available at modal-python.readthedocs.io/en/latest/content/query_strategies/uncertainty_sampling.html, each of which is incorporated herein by reference. As can be appreciated, the re-training dataset generated by sampling module 806a comprises the unlabeled data which is expected to be the most informative for improving model performance.

Once the re-training dataset is generated, model training module 806b executes (step 906) the trained classification model 807 using the re-training dataset as input to generate labels for the re-training dataset. The labels generated by model 807 for the re-training dataset may not be accurate because as described above, the re-training dataset has been sampled from the unlabeled investment data according to an uncertainty measure.

After application of the labels to the re-training dataset by model 807, labeling module 808 of server computing device 806 provides the newly labeled investment data to a remote computing device (e.g., device 802) associated with a portfolio manager. For example, labeling module 808 can display the investment data and associated labels to the PM for review and approval. The PM can confirm labels that match their investment philosophy and/or provide input that changes one or more of the labels that do not match their investment philosophy. For example, when model 807 labels a particular investment data point with a label (e.g., ‘underappreciated winner’) and the PM determines that the investment data point should have a different label (e.g., ‘noise), the PM can change the label and submit the change to labeling module 808. Labeling module 808 receives (step 908) the change to the label(s) applied to the re-training dataset from remote computing device 102.

Labeling module 808 provides the changed re-training dataset to teacher module 809, which re-trains (step 910) the trained investment classification model 807 on the changed re-training dataset. Because the PM has provided actual ‘ground truth’ labels to the re-training dataset sampled from the corpus of unlabeled data, teacher module 809 can re-train model 807 to improve the accuracy of the trained classification model while requiring only a small amount of training data—thereby providing for a much more data-efficient way to generate investment alignment predictions for PMs. Once the teacher module 809 has re-trained the model 807, server computing device 806 can deploy the model to generate (step 912) a predicted investment alignment for one or more PMs. In some embodiments, model scoring module 806c analyzes the re-trained investment classification model as described above with respect to FIG. 6. In some embodiments, sampling module 806a and model training module 806b repeat the above model re-training process one or more times, each time sampling a different subset of data from database 812 to further re-train model 807.

Transfer Learning

In another aspect, the systems and methods can use transfer learning techniques to generate trained classification models for PMs that remove noise which can bias or skew the classification labels generated by the model. Generally, transfer learning is a process whereby output from a pre-trained model (typically created for a first task) is used as a starting point for quickly generating a trained model for a second task. Transfer learning enables the system to leverage already-trained models to generate new models for other specific applications without requiring duplication of effort and/or expenditure of significant computing resources to generate the second model. Additional information about the implementation of transfer learning techniques for classification models is described in I. Li, “Detecting Bias in Transfer Learning Approaches for Text Classification,” arXiv:2102.002114v1 [cs.CL] 3 Feb. 2021, and M. Iman et al., “A Review of Deep Transfer Learning and Recent Advancements,” arXiv:2201.09679v2 [cs.LG] 22 Dec. 2022, each of which is incorporated herein by reference.

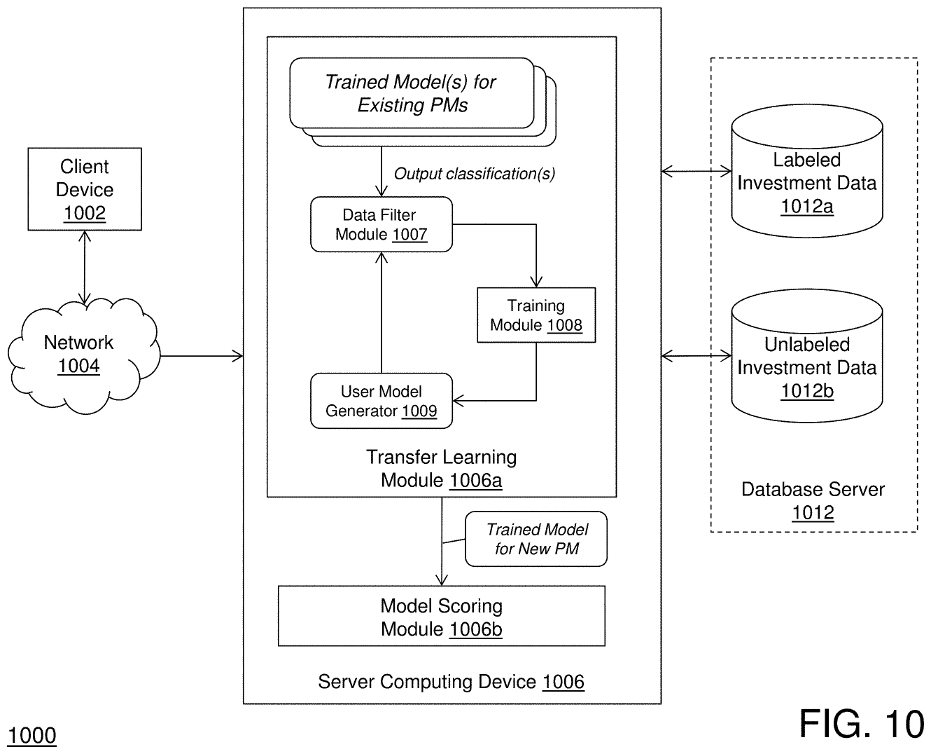

FIG. 10 is a block diagram of a system 1000 for generating an investment classification model using transfer learning. System 1000 includes certain devices and components that are described above with respect to FIGS. 1-9 and those devices and components are discussed by way of reference thereto. As shown in FIG. 10, system 1000 includes client computing device 1002, communication network 1004, server computing device 1006 that includes transfer learning module 1006a and model scoring module 1006b. Transfer learning module 1006a includes data filter module 1007, training module 1008, and user model generator module 1009. System 1000 also includes database server computing device 1012 that comprises historical data database 1012a and unlabeled data database 1012b.

Client computing device 1002 connects to communication network 1004 in order to communicate with server computing device 1006 to provide input and receive output relating to the process of generating an investment classification model using transfer learning as described herein. In some embodiments, client computing device 1002 is coupled to an associated display device (not shown). For example, client computing device 1002 can provide a graphical user interface (GUI) via the display device that is configured to receive input from a user of the device 1002 and to present output (e.g., documents, reports, digital content items) to the user that results from the methods and systems described herein.

Exemplary client computing devices 1002 include but are not limited to desktop computers, laptop computers, tablets, mobile devices, smartphones, and Internet appliances. It should be appreciated that other types of computing devices that are capable of connecting to the components of system 1000 can be used without departing from the scope of invention. Although FIG. 10 depicts a single client computing device 1002, it should be appreciated that system 1000 can include any number of client computing devices.

Communication network 1004 enables the client computing device 1002 to communicate with server computing device 1006. Network 1004 is typically a wide area network, such as the Internet and/or a cellular network. In some embodiments, network 1004 is comprised of several discrete networks and/or sub-networks (e.g., cellular to Internet).

Server computing device 1006 is a device including specialized hardware and/or software modules that execute on a processor and interact with memory modules of server computing device 1006, to receive data from other components of system 1000, transmit data to other components of system 1000, and perform functions for generating an investment classification model using transfer learning as described herein. As mentioned above, server computing device 1006 includes transfer learning module 1006a which includes data filter module 1007, training module 1008, and user model generator 1009, and model scoring module 1006b which execute on one or more processors of server computing device 806. In some embodiments, modules 1006a, 1006b, 1007, 1008, and 1009 are specialized sets of computer software instructions programmed onto one or more dedicated processors in server computing device 1006 and can include designated memory locations and/or registers for executing the specialized computer software instructions.

Although modules 1006a, 1006b, 1007, 1008, and 1009 are shown in FIG. 10 as executing within the same server computing device 806, in some embodiments the functionality of modules 1006a, 1006b, 1007, 1008, and 1009 can be distributed among a plurality of server computing devices. As shown in FIG. 10, server computing device 1006 enables modules 1006a, 1006b, 1007, 1008, and 1009 to communicate in order to exchange data for the purpose of performing the described functions. It should be appreciated that any number of computing devices, arranged in a variety of architectures, resources, and configurations (e.g., cluster computing, virtual computing, cloud computing) can be used without departing from the scope of the invention. Exemplary functionality of modules 1006a, 1006b, 1007, 1008, and 1009 is described in detail below.

Database server 1012 is a computing device (or set of computing devices) coupled to server computing device 1006 and the databases are configured to receive, generate, and store specific segments of data relating to the process of generating an investment classification model using transfer learning as described herein. Database server 1012 comprises a plurality of databases, including historical investment data database 1012a and unlabeled investment data database 1012b. In some embodiments, all or a portion of the databases 1012a-1012b can be integrated with server computing device 1006 or be located on a separate computing device or devices. Databases 1012a-1012b can comprise one or more databases configured to store portions of data used by the other components of system 1000, as will be described in greater detail below.

As can be appreciated, labeled investment data database 1012a comprises investment data that has been previously labeled to indicate whether the investment data or a portion thereof aligns with one or more investment strategies (i.e., an investment strategy preferred by a given portfolio manager (PM)). An example label can be a binary value (e.g., 0 for non-aligning or noise, 1 for aligning), an alphanumeric value (e.g., indicating the alignment determination), or other types of labeling mechanisms. The data in labeled investment data database 1012a can comprise data that has been manually labeled (e.g., by the PM and/or an analyst) and/or data that has been previously analyzed and labeled by system 100 of FIG. 1 and/or system 800 of FIG. 8. In some embodiments, the labeled investment data comprises time series investment data. Unlabeled investment data database 1012b comprises investment data that has not yet been labeled for alignment with an investment strategy—as explained herein, this data is analyzed to discover ‘ground truth’ alignment labels and/or pseudolabels associated with one or more other PMs for certain investment data points, which are then used to filter training data used to generate an investment classification model for a new PM. For example, system 1000 can be configured to generate an investment classification model for a new PM during an onboarding process (i.e., the new PM is being integrated into the system but has not yet provided any insight or labels associated with their investment philosophy). Instead of training a new classification model for the PM from scratch, system 1000 can leverage transfer learning principles to kick-start generation of the model from a much more favorable position than, e.g., a randomly initialized starting point.

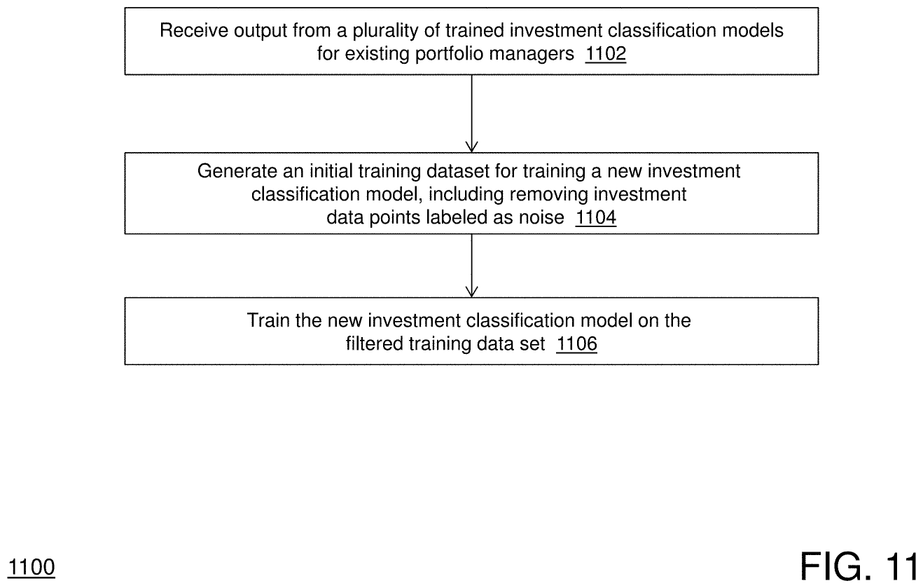

FIG. 11 is a flow diagram of a computerized method 1100 of generating an investment classification model using transfer learning, using system 1000 of FIG. 10. Data filter module 1007 receives (step 1102) output (e.g., investment data points and corresponding classification labels) from a plurality of trained classification models for existing portfolio managers. In some embodiments, data filter module 1007 receives investment data points (i.e., charts and/or time series data) and labels that are associated with a specific type of classification (such as ‘noise’) from each of the existing trained models. As described previously, many different PMs may consider certain investment data as ‘noise’ (i.e., not relevant to, or contradictory to, their investment philosophy). The classification models for these PMs can generate a ‘noise’ label for this type of investment data, which is provided to data filter module 1007. In some embodiments, data filter module 1007 can receive output from one or more trained classification models for existing PMs that share one or more characteristics with the new PM for which a model is being built. For example, a new PM may have designated certain characteristics about themselves and/or their investment philosophy in a user profile when signing up to access the system. Data filter module 1007 can select output from the trained models associated with PMs that have similar characteristics.

Data filter module 1007 generates an initial training dataset for training a new classification model (e.g., by retrieving data from database 1012a) and removes (step 1104) one or more investment data points from the training dataset that were labeled as ‘noise’ (or another label) by the trained classification models for the one or more existing PMs. As can be appreciated, PMs with similar characteristics may tend to agree on what should be considered as ‘noise’ to their investment philosophy. Under this principle, filtering out these investment data points from the training dataset for a classification model for a new PM reduces the amount of time needed for training, as well as results in a more accurate classification model for the new PM (which may require fewer re-training cycles).

After filtering the training dataset, user model generator 1009 trains (step 1106) an investment classification model on the filtered training dataset to generate investment alignment predictions for the new PM. The newly trained classification model can be deployed for use in generating predictions for the new PM. In some embodiments, model scoring module 806b analyzes the newly trained investment classification model as described above with respect to FIG. 6.

Semi-Supervised Learning

In another aspect, the systems and methods can use semi-supervised learning techniques to improve the performance of trained investment classification models through the generation of ‘noisy ground truth’ training data. Generally, semi-supervised learning involves the training of a classification model using a small corpus of labeled training data and a large corpus of unlabeled training data. Advantageously, by applying simple rules and heuristics to the unlabeled training data that generate low-accuracy (or noisy) ground truth labels, the resulting model performance can be greatly improved.

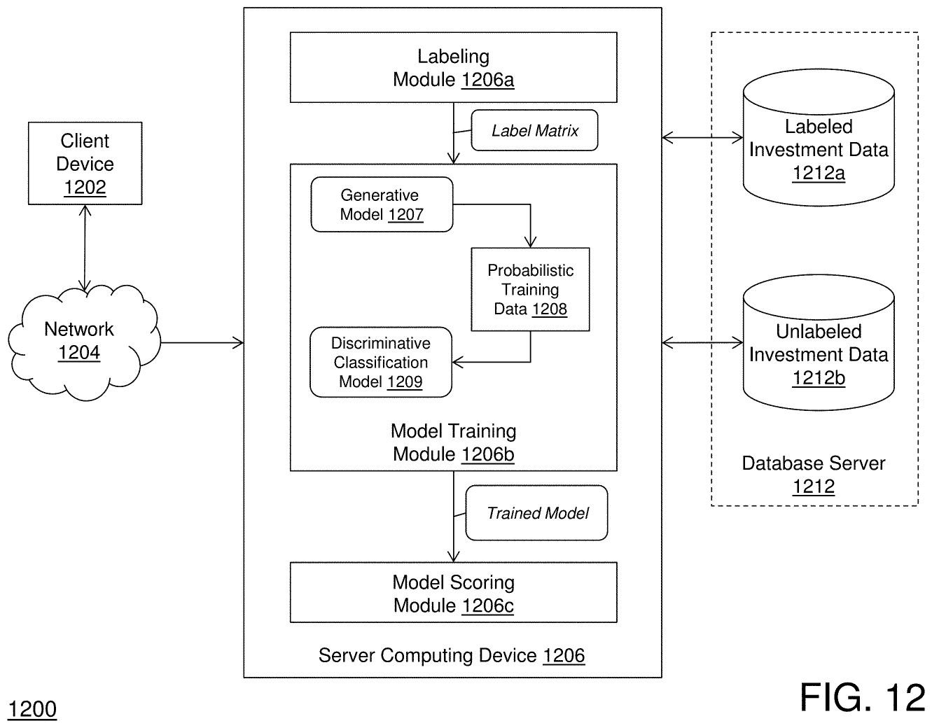

FIG. 12 is a block diagram of a system 1200 for generating a discriminative investment classification model using noisy ground truth data. In some embodiments, system 1200 is based upon the Snorkel architecture as described in S. H. Bach, et al., “Snorkel DryBell: A Case Study in Deploying Weak Supervision at Industrial Scale,” 2019 International Conference on Management of Data (SIGMOD '19), Jun. 30-Jul. 5, 2019, Amsterdam, Netherlands, arXiv:1812.00417v2 [cs.LG] 3 Jun. 2019, available at arxiv.org/pdf/1812.00417.pdf, which is incorporated herein by reference. System 1200 includes certain devices and components that are described above with respect to FIGS. 1-11 and those devices and components are discussed by way of reference thereto. As shown in FIG. 12, system 1200 includes client computing device 1202, communication network 1204, server computing device 1206 that includes labeling module 1206a, model training module 1206b, and model scoring module 1206c. Model training module 1206b includes generative model 1207, probabilistic training data 1208, and discriminative classification model 1209. System 1200 also includes database server computing device 1212 that comprises labeled investment data database 1212a and unlabeled investment data database 1212b.

Client computing device 1202 connects to communication network 1204 in order to communicate with server computing device 1206 to provide input and receive output relating to the process of generating a discriminative investment classification model using noisy ground truth data as described herein. In some embodiments, client computing device 1202 is coupled to an associated display device (not shown). For example, client computing device 1202 can provide a graphical user interface (GUI) via the display device that is configured to receive input from a user of the device 1202 and to present output (e.g., documents, reports, digital content items) to the user that results from the methods and systems described herein.

Exemplary client computing devices 1202 include but are not limited to desktop computers, laptop computers, tablets, mobile devices, smartphones, and Internet appliances. It should be appreciated that other types of computing devices that are capable of connecting to the components of system 1200 can be used without departing from the scope of invention. Although FIG. 12 depicts a single client computing device 1202, it should be appreciated that system 1200 can include any number of client computing devices.

Communication network 1204 enables the client computing device 1202 to communicate with server computing device 1206. Network 1204 is typically a wide area network, such as the Internet and/or a cellular network. In some embodiments, network 1204 is comprised of several discrete networks and/or sub-networks (e.g., cellular to Internet).

Server computing device 1206 is a device including specialized hardware and/or software modules that execute on a processor and interact with memory modules of server computing device 806, to receive data from other components of system 1200, transmit data to other components of system 1200, and perform functions for generating a discriminative investment classification model using noisy ground truth data as described herein. As mentioned above, server computing device 1206 includes labeling module 1206a, model training module 1206b which includes generative model 1207, probabilistic training data 1208, and discriminative classification model 1209, and model scoring module 1206c which execute on one or more processors of server computing device 1206. In some embodiments, modules 1206a-1206c and models 1207, 1209 are specialized sets of computer software instructions programmed onto one or more dedicated processors in server computing device 806 and can include designated memory locations and/or registers for executing the specialized computer software instructions.

Although modules 1206a-1206c and models 1207, 1209 are shown in FIG. 12 as executing within the same server computing device 1206, in some embodiments the functionality of modules 1206a-1206c and models 1207, 1209 can be distributed among a plurality of server computing devices. As shown in FIG. 12, server computing device 1206 enables modules 1206a-1206c and models 1207, 1209 to communicate in order to exchange data for the purpose of performing the described functions. It should be appreciated that any number of computing devices, arranged in a variety of architectures, resources, and configurations (e.g., cluster computing, virtual computing, cloud computing) can be used without departing from the scope of the invention. Exemplary functionality of modules 1206a-1206c and models 1207, 1209 is described in detail below.

Database server 1212 is a computing device (or set of computing devices) coupled to server computing device 1206 and the databases are configured to receive, generate, and store specific segments of data relating to the process of generating a discriminative investment classification model using noisy ground truth data as described herein. Database server 1212 comprises a plurality of databases, including labeled investment data database 1212a and unlabeled investment data database 1212b. In some embodiments, all or a portion of the databases 1212a-1212b can be integrated with server computing device 1206 or be located on a separate computing device or devices. Databases 1212a-1212b can comprise one or more databases configured to store portions of data used by the other components of system 1200, as will be described in greater detail below.

As can be appreciated, labeled investment data database 1212a comprises investment data that has been previously labeled to indicate whether the investment data or a portion thereof aligns with one or more investment strategies (i.e., an investment strategy preferred by a given portfolio manager (PM)). An example label can be a binary value (e.g., 0 for non-aligning or noise, 1 for aligning), an alphanumeric value (e.g., indicating the alignment determination), or other types of labeling mechanisms. The data in labeled investment data database 1212a can comprise data that has been manually labeled (e.g., by the PM and/or an analyst) and/or data that has been previously analyzed and labeled by system 100 of FIG. 1 and/or system 800 of FIG. 8. In some embodiments, the labeled investment data comprises time series investment data. Unlabeled investment data database 1212b comprises investment data that has not yet been labeled for alignment with an investment strategy—as explained herein, this data is labeled using one or more labeling functions and used to create a generative model for application of probabilistic labels to the investment data points.

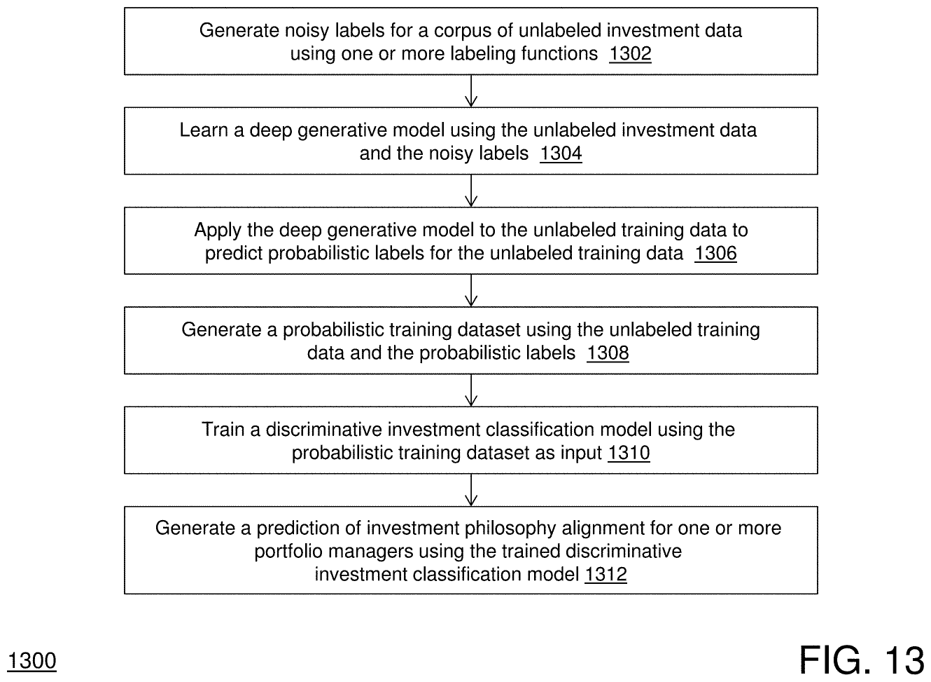

FIG. 13 is a flow diagram of a computerized method 1300 of generating a discriminative investment classification model using noisy ground truth data, using system 1200 of FIG. 12. Labeling module 1206a retrieves a corpus of unlabeled investment data from database 1212b and generates (step 1302) noisy labels for the unlabeled investment data using one or more labeling functions. Generally, each labeling function comprises programmatic code corresponding to one or more rules or heuristics that express weak supervision. An exemplary labeling function for an underappreciated winner investment classification can be generated as follows:
1) Determine basic concepts or definitions for the classification—e.g., an underappreciated winner can exhibit strong relative stock performance.
2) Translate the above concepts to simple rules:
   a. Slope of relative stock performance>0; and
   b. Slope of relative stock performance increases over time.
3) Generate a programmatic labeling function for each of the simple rules:
@labeling function( )
def REL_TSR_DIFF_PCT_12M_15(x):
   if x.REL_TSR_DIFF_PCT_12M>15:
      return Underappreciated Winner
   return abstain
@labeling function( )
def REL_TSR_TVALUE_12M_15(x):
   if x.REL_TSR_TRENDSCAN_LAST_12M>15:
      return Underappreciated Winner
   return abstain

Labeling module 1206a applies the labeling function(s) to the unlabeled investment data to generate the noisy labels. In some embodiments, labeling module 1206a aggregates the noisy labels into a label matrix that is transmitted to model training module 1206b.

Model training module 1206b learns (step 1304) a deep generative model 1207 using the unlabeled investment data and the noisy labels. In some embodiments, the deep generative model comprises a probabilistic model that can generate predictions (i.e., probabilistic labels) for the unlabeled training data. Generally, module 1206b digests each labeling function according to, e.g., labeling propensity (Lab), accuracy (Acc), and pairwise correlation (Corr):

ϕ_{i, j}^{Lab}(Λ, Y)= [symbol] {Λ_{i, j}≠Ø}

ϕ_{i, j}^{Acc}(Λ, Y)= [symbol] {Λ_{i, j}=yᵢ}

ϕ_{i, j, k}^{Corr}(Λ, Y)= [symbol] {Λ_{i, j}=Λ_{i, k}} (j, k)∈C

Module 1206b then defines the parametric model:

$${p}_{w} ( Λ , Y ) = {Z}_{w}^{- 1} exp ( {\sum }_{i = 1}^{m} {w}^{T} {ϕ}_{i} ( Λ , {y}_{i} ) )$$

Module 1206b learns the parameter without access to the ground truth labels Y by minimizing negative log marginal likelihood:

$$\hat{w} = \begin{matrix}arg min \\ w\end{matrix} - log {\sum }_{Y} {p}_{w} ( Λ , Y )$$

Module 1206b then uses the generative model 1207 to generate probabilistic training labels:

\tilde{Y}ᵢ=P_{ŵ}(Yᵢ|Λ)

Exemplary techniques for implementing a generative model 1207 using noisy labeled data are described in H. Bae et al., “From Noisy Prediction to True Label: Noisy Prediction Calibration via Generative Model,” Proceedings of the 39^{th} International Conference on Machine Learning, Baltimore, Maryland, Jul. 17-23, 2022, PMLR Vol. 162, which is incorporated herein by reference.

Model training module 1206b executes (step 1306) generative model 1207 on the unlabeled training data to predict probabilistic labels for the unlabeled training data. Model training module 1206b generates (step 1308) a probabilistic training dataset 1208 using the unlabeled training data and the probabilistic labels. Once the probabilistic labels are generated, model training module 1206b trains (step 1310) a discriminative investment classification model 1209 using the probabilistic training dataset 1208 as input. Example structures for the discriminative investment classification model 1209 can include, but are not limited to, logistic regression, support vector machine, neural networks, Random Forest, among others. The newly trained discriminative investment classification model can be deployed for use in generating (step 1312) a prediction of investment philosophy alignment for one or more portfolio managers using, e.g., investment data source from databases 1212a, 1212b. In some embodiments, model scoring module 1206c analyzes the trained discriminative investment classification model as described above with respect to FIG. 6.

The systems and methods described herein use artificial intelligence and machine learning to learn a portfolio manager's philosophy. The systems and methods described herein are able to adapt over time to different factors such as market regimes, changes in philosophy, and is able to accurately tailor itself to a specific portfolio manager in a consistent manner.

The above-described techniques can be implemented in digital and/or analog electronic circuitry, or in computer hardware, firmware, software, or in combinations of them. The implementation can be as a computer program product, i.e., a computer program tangibly embodied in a machine-readable storage device, for execution by, or to control the operation of, a data processing apparatus, e.g., a programmable processor, a computer, and/or multiple computers. A computer program can be written in any form of computer or programming language, including source code, compiled code, interpreted code and/or machine code, and the computer program can be deployed in any form, including as a stand-alone program or as a subroutine, element, or other unit suitable for use in a computing environment. A computer program can be deployed to be executed on one computer or on multiple computers at one or more sites. The computer program can be deployed in a cloud computing environment (e.g., Amazon® AWS, Microsoft® Azure, IBM®).

Method steps can be performed by one or more processors executing a computer program to perform functions of the invention by operating on input data and/or generating output data. Method steps can also be performed by, and an apparatus can be implemented as, special purpose logic circuitry, e.g., a FPGA (field programmable gate array), a FPAA (field-programmable analog array), a CPLD (complex programmable logic device), a PSoC (Programmable System-on-Chip), ASIP (application-specific instruction-set processor), or an ASIC (application-specific integrated circuit), or the like. Subroutines can refer to portions of the stored computer program and/or the processor, and/or the special circuitry that implement one or more functions.

Processors suitable for the execution of a computer program include, by way of example, special purpose microprocessors specifically programmed with instructions executable to perform the methods described herein, and any one or more processors of any kind of digital or analog computer. Generally, a processor receives instructions and data from a read-only memory or a random access memory or both. The essential elements of a computer are a processor for executing instructions and one or more memory devices for storing instructions and/or data. Memory devices, such as a cache, can be used to temporarily store data. Memory devices can also be used for long-term data storage. Generally, a computer also includes, or is operatively coupled to receive data from or transfer data to, or both, one or more mass storage devices for storing data, e.g., magnetic, magneto-optical disks, or optical disks. A computer can also be operatively coupled to a communications network in order to receive instructions and/or data from the network and/or to transfer instructions and/or data to the network. Computer-readable storage mediums suitable for embodying computer program instructions and data include all forms of volatile and non-volatile memory, including by way of example semiconductor memory devices, e.g., DRAM, SRAM, EPROM, EEPROM, and flash memory devices; magnetic disks, e.g., internal hard disks or removable disks; magneto-optical disks; and optical disks, e.g., CD, DVD, HD-DVD, and Blu-ray disks. The processor and the memory can be supplemented by and/or incorporated in special purpose logic circuitry.

To provide for interaction with a user, the above described techniques can be implemented on a computing device in communication with a display device, e.g., a CRT (cathode ray tube), plasma, or LCD (liquid crystal display) monitor, a mobile device display or screen, a holographic device and/or projector, for displaying information to the user and a keyboard and a pointing device, e.g., a mouse, a trackball, a touchpad, or a motion sensor, by which the user can provide input to the computer (e.g., interact with a user interface element). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, and/or tactile input.

The above-described techniques can be implemented in a distributed computing system that includes a back-end component. The back-end component can, for example, be a data server, a middleware component, and/or an application server. The above described techniques can be implemented in a distributed computing system that includes a front-end component. The front-end component can, for example, be a client computer having a graphical user interface, a Web browser through which a user can interact with an example implementation, and/or other graphical user interfaces for a transmitting device. The above described techniques can be implemented in a distributed computing system that includes any combination of such back-end, middleware, or front-end components.

The components of the computing system can be interconnected by transmission medium, which can include any form or medium of digital or analog data communication (e.g., a communication network). Transmission medium can include one or more packet-based networks and/or one or more circuit-based networks in any configuration. Packet-based networks can include, for example, the Internet, a carrier internet protocol (IP) network (e.g., local area network (LAN), wide area network (WAN), campus area network (CAN), metropolitan area network (MAN), home area network (HAN)), a private IP network, an IP private branch exchange (IPBX), a wireless network (e.g., radio access network (RAN), Bluetooth, near field communications (NFC) network, Wi-Fi, WiMAX, general packet radio service (GPRS) network, HiperLAN), and/or other packet-based networks. Circuit-based networks can include, for example, the public switched telephone network (PSTN), a legacy private branch exchange (PBX), a wireless network (e.g., RAN, code-division multiple access (CDMA) network, time division multiple access (TDMA) network, global system for mobile communications (GSM) network), and/or other circuit-based networks.

Information transfer over transmission medium can be based on one or more communication protocols. Communication protocols can include, for example, Ethernet protocol, Internet Protocol (IP), Voice over IP (VOIP), a Peer-to-Peer (P2P) protocol, Hypertext Transfer Protocol (HTTP), Session Initiation Protocol (SIP), H.323, Media Gateway Control Protocol (MGCP), Signaling System #7 (SS7), a Global System for Mobile Communications (GSM) protocol, a Push-to-Talk (PTT) protocol, a PTT over Cellular (POC) protocol, Universal Mobile Telecommunications System (UMTS), 3GPP Long Term Evolution (LTE) and/or other communication protocols.

Devices of the computing system can include, for example, a computer, a computer with a browser device, a telephone, an IP phone, a mobile device (e.g., cellular phone, personal digital assistant (PDA) device, smart phone, tablet, laptop computer, electronic mail device), and/or other communication devices. The browser device includes, for example, a computer (e.g., desktop computer and/or laptop computer) with a World Wide Web browser (e.g., Chrome™ from Google, Inc., Microsoft® Internet Explorer® available from Microsoft Corporation, and/or Mozilla® Firefox available from Mozilla Corporation). Mobile computing device include, for example, a Blackberry® from Research in Motion, an iPhone® from Apple Corporation, and/or an Android™-based device. IP phones include, for example, a Cisco® Unified IP Phone 7985G and/or a Cisco® Unified Wireless Phone 7920 available from Cisco Systems, Inc.

Comprise, include, and/or plural forms of each are open ended and include the listed parts and can include additional parts that are not listed. And/or is open ended and includes one or more of the listed parts and combinations of the listed parts.

One skilled in the art will realize the subject matter may be embodied in other specific forms without departing from the spirit or essential characteristics thereof. The foregoing embodiments are therefore to be considered in all respects illustrative rather than limiting of the subject matter described herein.

What is claimed is:

1. A system for re-training an investment recommendation classification model using active learning, the system comprising a server computing device having a memory for storing computer-executable instructions and a processor that executes the computer-executable instructions to:
train an investment classification model on a corpus of labeled investment data, the trained investment classification model configured to generate investment philosophy alignment predictions for a plurality of portfolio managers;
sample a re-training dataset from a corpus of unlabeled investment data;
execute the trained investment classification model using the re-training dataset as input to generate labels for the investment data in the re-training dataset;
receive a change to one or more of the generated labels from a remote computing device;
re-train the trained investment classification model on the changed re-training dataset; and
generate a prediction of investment philosophy alignment for one or more portfolio managers and one or more investment data points using the re-trained investment classification model.

2. The system of claim 1, wherein the investment data comprises historical stock price data for a plurality of companies.

3. The system of claim 1, wherein the server computing device uses a classification uncertainty sampling algorithm to sample the re-training dataset from the corpus of unlabeled investment data.

4. A computerized method of re-training an investment recommendation classification model using active learning, the method comprising:
training, by a server computing device, an investment classification model on a corpus of labeled investment data, the trained investment classification model configured to generate investment philosophy alignment predictions for a plurality of portfolio managers;
sampling, by the server computing device, a re-training dataset from a corpus of unlabeled investment data;
executing, by the server computing device, the trained investment classification model using the re-training dataset as input to generate labels for the investment data in the re-training dataset;
receiving, by the server computing device, a change to one or more of the generated labels from a remote computing device;
re-training, by the server computing device, the trained investment classification model on the changed re-training dataset; and
generating, by the server computing device, a prediction of investment philosophy alignment for one or more portfolio managers and one or more investment data points using the re-trained investment classification model.

5. The method of claim 4, wherein the investment data comprises historical stock price data for a plurality of companies.

6. The method of claim 4, wherein the server computing device uses a classification uncertainty sampling algorithm to sample the re-training dataset from the corpus of unlabeled investment data.

7. A system for generating an investment classification model using transfer learning, the system comprising a server computing device having a memory for storing computer-executable instructions and a processor that executes the computer-executable instructions to:
receive output from a plurality of trained investment classification models for one or more existing portfolio managers, the output comprising investment data and corresponding labels generated by the plurality of trained models;
generate an initial training dataset for training a new investment classification model, including removing one or more investment data points from the output received from the plurality of trained models that are labeled as noise; and
train a new investment classification model using the filtered training dataset as input to generate investment philosophy alignment predictions for a new portfolio manager.

8. A computerized method of generating an investment classification model using transfer learning, the method comprising:
receiving, by a server computing device, output from a plurality of trained investment classification models for one or more existing portfolio managers, the output comprising investment data and corresponding labels generated by the plurality of trained models;
generating, by the server computing device, an initial training dataset for training a new investment classification model, including removing one or more investment data points from the output received from the plurality of trained models that are labeled as noise; and
training, by the server computing device, a new investment classification model using the filtered training dataset as input to generate investment philosophy alignment predictions for a new portfolio manager.

9. A system for generating a discriminative investment classification model using noisy ground truth data, the system comprising a server computing device having a memory for storing computer-executable instructions and a processor that executes the computer-executable instructions to:
generate noisy labels for a corpus of unlabeled investment data using one or more labeling functions;
learn a deep generative model using the unlabeled investment data and the noisy labels;
apply the deep generative model to the unlabeled training data to predict probabilistic labels for the unlabeled training data;
generate a probabilistic training dataset using the unlabeled training data and the probabilistic labels;
train a discriminative investment classification model using the probabilistic training dataset as input; and
generate a prediction of investment philosophy alignment for one or more portfolio managers and one or more investment data points using the trained discriminative investment classification model.

10. The system of claim 9, wherein the labeling functions each comprise programmatic code corresponding to one or more rules or heuristics that express weak supervision.

11. A computerized method of generating a discriminative investment classification model using noisy ground truth data, the method comprising:
generating, by a server computing device, noisy labels for a corpus of unlabeled investment data using one or more labeling functions;
learning, by the server computing device, a deep generative model using the unlabeled investment data and the noisy labels;
applying, by the server computing device, the deep generative model to the unlabeled training data to predict probabilistic labels for the unlabeled training data;
generating, by the server computing device, a probabilistic training dataset using the unlabeled training data and the probabilistic labels;
training, by the server computing device, a discriminative investment classification model using the probabilistic training dataset as input; and
generating, by the server computing device, a prediction of investment philosophy alignment for one or more portfolio managers and one or more investment data points using the trained discriminative investment classification model.

12. The method of claim 11, wherein the labeling functions each comprise programmatic code corresponding to one or more rules or heuristics that express weak supervision.
